(19) United States
(12) Patent Application Publication
(10) Pub. No.: US 2006/0150237 A1
(43) Pub. Date: Jul. 6, 2006

(54) Time-shift add-on device for apparatus with scart connection

(75) Inventors: Ozcan Mesut, Eindhoven (NL); Edwin Andre Montie, Eindhoven (NL); Peter Hidding, Eindhoven (NL); Antonius Ludovicus Johannes Cornelis Heijnen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/545,649

(22) PCT Filed: Feb. 9, 2004
(86) PCT No.: PCT/IB04/50086

§ 371 Date: Aug. 16, 2005

(30) Foreign Application Priority Data
Feb. 21, 2003 (EP) 03100422.9

(51) Int. Cl. H04N 7/16

(52) U.S. Cl. 725/151

(57) ABSTRACT

A stand-alone time-shift device can be connected to a TV-set via a SCART connector. The device offers a “pause-button” functionality to the user watching a live broadcast. Special control of the SCART's pin-8 avoids delay in the response or artifacts on the screen when the user is changing channels. This allows adding the time-shift functionality without interfering with the conventional behavior of a TV set.

### FIELD OF THE INVENTION

The invention relates to a device for adding a time-shift functionality to an apparatus with a receiver for receiving content information such as a TV set, a radio set, a set-top box, or a PC configured to receive streaming or broadcast video.

### BACKGROUND ART

Digital video recorders (DVR), also referred to as Personal Video Recorders (PVR), are apparatus that use digital technologies to record broadcast TV programs on a hard disk drive (HDD). Examples of commercially available DVR equipment include the Philips-Tivo Digital Video Recorders and Panasonic's high-end TV with built-in ReplayTV PVR. Both Tivo and Replay use recorders that include a tuner. Such an apparatus can be controlled manually to record a specific show on air, and can be programmed in advance and with the help of an electronic program guide (EPG) or other service to automatically record future programs. In addition to recording live TV programs on a HDD, DVRs enable the user to pause a live broadcast and resume watching it from where it got paused, to rewind in order to watch a scene again, and to use trick-modes such as fast reverse and slow motion.

### SUMMARY OF THE INVENTION

The inventors have recognized that some aspects of the known products could be simplified substantially from the point of view of the end-user. For example, TVs with built-in DVRs are high-end products and therefore relatively expensive. As another example, connecting a commercially available DVR to one's TV set and external network (e.g., Internet) for the services, is relatively simple for the technically interested user, but not to every layperson. As another example, user-interaction with stand-alone DVRs typically requires the use of a separate remote control device in addition to the one for operating one's TV set. In summary, the inventors have recognized the problem of costs, installation difficulties and ergonomic user interaction associated with existing DVRs.

The inventors therefore propose a low-cost implementation of a lean version of a DVR in the form of an add-on device or after-market device that enables to add a time-shift functionality to a legacy TV set or any other legacy receiver. To this end, the invention provides a device for adding a time-shift functionality to an apparatus with a receiver for receiving content information. The receiver has a tuner and a first connector with an external signal input, an external signal output, and a function switch control input. For example, TV sets with a SCART connector have these external inputs and output The tuner is connected to the external signal output for supplying first content information. The apparatus has a first operational mode, wherein the first content information is being rendered. That is, the tuner output follows a conventional processing path within the receiver to the display monitor and/or loudspeaker. The apparatus also has a second operational mode, wherein second content information is being rendered as received at the external signal input. The device in the invention comprises a second connector for coupling a memory to the first connector. The device has a third operational mode, wherein the device controls the apparatus via the function control input to be in the first operational mode and wherein the device enables the first content information to be recorded in the memory. The device also has a fourth operational mode for enabling the first content information to be recorded in the memory, for controlling the apparatus via the function control input to be in the second operational mode and for enabling the second content information to be supplied from the memory.

Preferably, the third mode is entered after a power on of the apparatus or after detecting a channel change of the apparatus. As to the latter, the device preferably comprises a detector for detecting a command for the apparatus, e.g., from the receiver's remote control, to change its channel.

In the third mode, the device enables the audio and/or video at the external output to be recorded. Preferably, playback from the memory is then paused, e.g., to improve performance and to lower acoustic noise from the device if the memory comprises an HDD. When a time-shift command, e.g., pause or fast-reverse, is given while the device is in the third mode, the device enters the fourth mode and switches the apparatus to its external input. In case of an apparatus with a SCART connector, the switching is accomplished by using the SCART's pin-8 (function switching input). In the fourth mode, the device continues to record the signal at the apparatus' external output.

The reason for entering the third mode upon a channel change command and upon a power-on command relates to fast channel changes, e.g., zapping. In the third mode, the user of, for example, a TV set is allowed to zap as fast as is usual with conventional TVs without an additional delay or artifacts caused by the device. A delay of, say, a few seconds is introduced if the video signal has to travel via the memory if that has an HDD.

The device in the invention preferably comprises a generator for generating data to be rendered by the apparatus together with the second content This serves as an indication to the user that he/she is watching, and/or listening to, recorded (i.e., not live) content.

The device itself may also comprise a tuner for receiving content information. Note that the pause or time-shift functionality as discussed above will be easier to use also with an additional tuner being available.

For completeness, note that Tivo supplies content always through the HDD, and that a VCR cannot read AND write at same time.

### BRIEF DESCRIPTION OF THE DRAWING

The invention is explained in further detail, by way of example and with reference to the accompanying drawing wherein:

FIG. 1 is a block diagram of a system using the device in the invention;

FIG. 2 is state diagram illustrating operation of the device in the invention.

Throughout the figures, same reference numerals indicate similar or corresponding features.

### DETAILED EMBODIMENTS

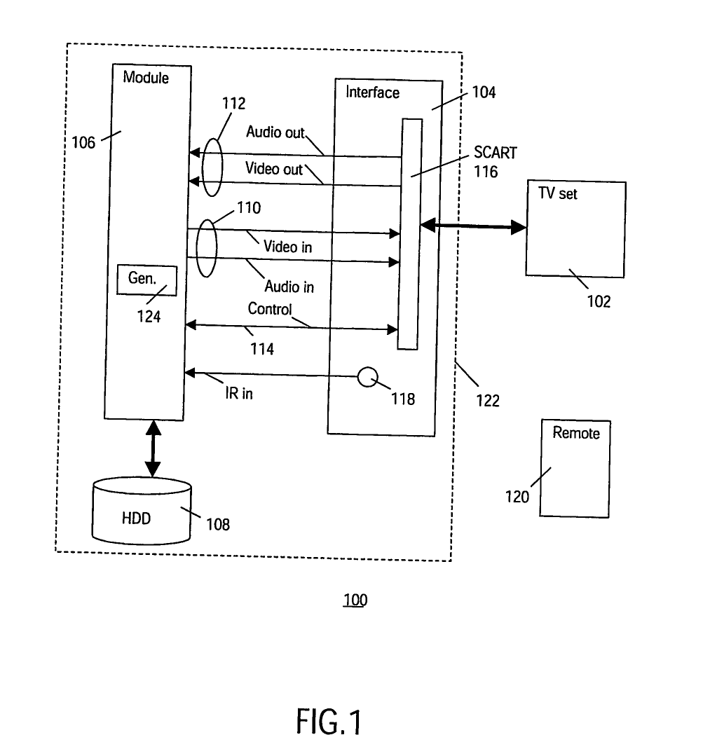

FIG. 1 is a block diagram of a system 100 in the invention. System 100 comprises a TV set 102, an interface 104, a processing module 106 and a memory 108. Interface 104 couples an external input 110 of TV set 102, an external output 112 of TV set 102 and a function control input 114 of TV set 102 to module 106. In this example, interface 104 comprises a SCART connection 116. Interface 104 also comprises a detector 118 (or a connector for connecting a detector 118) for detecting wireless (e.g., IR (infrared) or RF (radio frequency)) commands from a remote 120 manipulated by the user controlling TV set 102. Module 106 is connected to memory 108 (e.g., a HDD, a solid state memory, an optical disk such a DVD+RW). Module 106 controls the processing of the “video out” and “audio out” signals at output 112 for recording them as data in memory 108. Module 106 also controls the reading of the data stored in memory 108 and the supply of the “video in” signal and the “audio in” signal, representative of this data, to external input 110. To this end, module 106 comprises, e.g., A/D- and D/A converters (not shown), MPEG-encoders and -decoders (not shown). Module 106 further controls some operational modes of TV set 102 via function control input 114 as is described below. Operation of module 106 is controlled by the commands issued to TV set 102 by remote 120 that get detected by detector 118.

Preferably, interface 104, module 106 and memory 108 are accommodated in a device 122 so that the end-user only has to connect SCART plug 116 of device 122 to TV set 102 and the power plug (not shown) of device 122 to a power outlet.

Preferably, device 122 comprises a generator 124 for generating an or screen indicator (not shown) to be displayed when the user is watching recorded content from memory 108.

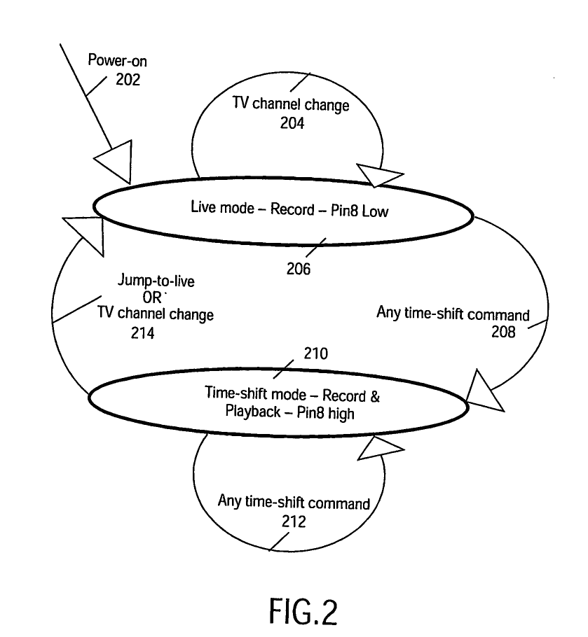

Operation of system 100 and device 122 is explained with reference to FIG. 2.

FIG. 2 is a state diagram 200 illustrating operation of system 100.

When detector 118 detects a power-on command 202 or a channel change command 204 issued by remote 120 to TV set 102, device 122 enters a live-mode 206. Module 106 then causes data to be recorded in memory 108, which is representative of the signals at external output 112. The signals at external output 112 are supplied by the tuner (not shown) of TV set 102 and are, in parallel, being rendered by TV set 102 at the screen of its display monitor (not shown) and its loudspeakers (not shown). Preferably, play-back from memory 108 is paused in the live mode. In case memory 108 comprises an HDD, this pausing improves performance and lowers acoustic noise. In live-mode 206, pin8 (here control input 114) of SCART plug 116 is low.

When detector 118 detects a time-shift command 208 (e.g., “pause” or “fast-reverse”) while device 122 is in live mode 206, device 122 proceeds to a time-shift mode 210. When entering time-shift mode 210, device 122 switches TV set 102 to its external input 110 by means of switching control input 114. In the example of FIG. 1, this means that pin8 of SCART plug 116 is switched to a high. In this mode 210, the information stored as data in memory 108 is available for being rendered by TV set 102, possibly after decoding and D/A conversion. In a trick play mode, this data is supplied to external input 110. In a pause mode, the frame of the content is being displayed that was, e.g., the last one being rendered before the pause command got processed. Alternatively, a graphics symbol as generated by module 106 is being displayed upon a pause command until play-out is being resumed. In mode 210, device 122 keeps recording the signals at output 112, i.e., the signals received by the tuner of TV set 102.

When device 122 is in time-shift mode 210, any time-shift command 212 received leaves the operational mode unchanged.

When device 122 is in time-shift mode 210 and receives a channel change command or a jump-to-live command 214, device 122 switches to live mode 206.

A good reason for entering live mode 206 upon a channel change or power-on is fast zapping. In live mode 206, the user is allowed to zap or surf the TV channels as fast as usual without any delay and artifacts being caused by device 122. If the signals rendered at TV set 102 were to be routed through memory 108 in live mode 206, a delay of, say, two seconds would be introduced between what the tuner of TV set 102 is receiving and what TV set is rendering. This is unacceptable when zapping fast through the channels as the content being rendered is then not that from the channel being tuned to at that moment. In the invention, the live TV signal being rendered is not routed via module 122 but follows the conventional route within TV set 102 from tuner to display. This has the additional advantage that closed captioning or teletext remains available if this cannot be recorded at memory 108.

Although above example illustrates use of the invention with a TV set, the invention can also be used with other types of receivers of (live) content, such as radio sets, PC's configured to handle streaming video, set-top boxes, etc.

1. A device for adding a time-shift functionality to an apparatus with a receiver for receiving content information, wherein:
the receiver has a tuner and a first connector with an external signal input, an external signal output, and a function switch control input;
the tuner is connected to the external signal output for supplying first content information;
the apparatus has a first operational mode wherein the first content information is being rendered;
the apparatus has a second operational mode wherein second content information is being rendered as received at the external signal input;
the device comprises a second connector for coupling a memory to the first connector;
the device has a third mode wherein the device controls the apparatus via the function control input to be in the first operational mode and wherein the device enables to record the first content information in the memory; and
the device has a fourth mode for enabling to record the first content information in the memory, for controlling the apparatus via the function control input to be in the second operational mode and for enabling to supply the second content information from the memory.

2. The device of claim 1, wherein the first and second connectors comprise SCART connectors.

3. The device of claim 1, wherein the third mode is entered after a power on of the apparatus.

4. The device of claim 1, wherein the third mode is entered after a channel change of the apparatus.

5. The device of claim 4, comprising a detector for detecting a command for the apparatus to change its channel.

6. The device of claim 1, accommodating the memory.

7. The device of claim 6, wherein the memory comprises a disk drive.

8. The device of claim 1, comprising a generator for generating data to be rendered by the apparatus together with the second content.

9. The device of claim 1, wherein the fourth mode is entered upon receipt of a time-shift command.

10. The device of claim 1, for use with a TV set.

11. The device of claim 1 for use with a set-top box.
